(19) United States
(12) Patent Application Publication
(10) Pub. No.: US 2020/0268588 A1
(43) Pub. Date: Aug. 27, 2020

(54) Independent Ambulatory Assistance System w/360 Fall Protection and Sit-to-Stand Assist

(71) Applicant: Dhawn Becker, Iron River, MI (US)

(72) Inventors: Donald Desmarais, Mabton, WA (US); Dhawn Becker, Iron River, MI (US)

(73) Assignee: Dhawn ., Iron River, MI (US)

(21) Appl. No.: 16/282,906

(22) Filed: Feb. 22, 2019

(51) Int. Cl. A61H 3/00; A63B 3/00

(52) U.S. Cl. CPC A61H 3/008; A61H 2201/1645; A61H 2201/0192; A63B 3/00

(57) ABSTRACT

An ambulatory assistance system that facilitates independent sit to stand exercise for use in homes and therapy centers that can have a minimal structural impact. The optional parallel bars can be hinged allowing movement relative to horizontal. The parallel bars can be secured in a horizontal position and the optional securing mechanism can be remotely released. The support frame system at least partially surrounds the individual and allows the individual to turn up to 360 while in the support frame system. In some embodiments, the support frame system is collapsible and includes one or more wheels, casters, leveling casters, or other structures configured to facilitate easier movement of the system from one location to another.

### TECHNICAL FIELD

The present disclosure generally relates to exercise, rehabilitation and caregiver assistance aids that enable a person to pull themselves up from a sitting position to a standing position, into an activity/exercise fall protection system. More particularly, the present disclosure relates to a frame that assists with guided sit to stand function, fall protection, balance, activity, and exercise.

### BACKGROUND

Individuals of any age or size can, at some time, find themselves in a condition needing assistance to stand, balance or walk independently due to a variety of causes (e.g., stroke, spinal cord injury, surgery, etc.). At these times in a person's life, the individual may be dependent upon a wheelchair for mobility and on an assistant to help them out of the wheelchair to stand and walk or exercise. For example, assistance may be required to perform exercises on a set of parallel bars on which the individuals supports themselves during the walking exercises or activities. However, in many cases, the individual lacks balance and upper body and arm strength and it is difficult for the individual to sufficiently support and/or balance herself or himself on the bars during the activity, especially when the individual reaches an end of the structure and needs to turn around to walk the other direction. Often an assistant must assist the individual to stand up and/or walk while on the support structure. When using the support structure without assistance, there is a potential that the individual will lose strength or balance and trip or fall. When in the home, many individuals with conditions that decrease balance ability and increase the possibility of falling, experience an intense fear of falling that hinders them from getting up and exercising, and results in increased muscle atrophy and/or serious injury for those who do venture attempts. These conditions can leave the individual dependent on the use of a wheelchair, thereby increasing their susceptibility to further weakness and injury. These conditions can increase length of time and cost to rehabilitate, increase need and expense for caregiver assistance, increase need and expense for nursing home care, and, sometimes, result in death of the individual.

### SUMMARY OF CERTAIN FEATURES

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of the system and methods provide several advantages over traditional systems and methods.

According to some variants, a support frame system for use with parallel bars can include a main body. The main body can have an opening. The support frame system can have at least one enclosure structure movable between an open and a closed position relative to the opening, the open position allowing a user to enter the support frame system and the closed position inhibiting the user from exiting the support frame system. In some embodiments, the support frame system includes a securing mechanism that secures the at least one enclosure structure in the closed position. In some embodiments, the enclosure structure is rotatable about a vertical axis.

In some embodiments, the support frame system further comprises at least one handle, the handle extending vertically from a top surface of the main body. In some embodiments, the support frame system further comprises at least one handle, the handle extending vertically from a top surface of the enclosure arm. In some embodiments, the support frame system further comprises a sliding mechanism that allows the main body to slide along the length of the parallel bars. In some embodiments, the main body and the at least one enclosure arm in the closed position create an interior area that accommodates a user and is sized to allow the user to turn up to 360 degrees. In some embodiments, the support frame system is free-standing (e.g., not connected to the ceiling, walls, or floor of the room or other enclosure in which the support frame system is installed). In some embodiments, the support frame system further comprises at least one cutout in the main body, the cutout positioned for the user to use. In some embodiments, the support frame system further comprises at least one cutout in the at least one enclosure arm, the cutout positioned for the user to use. In some embodiments, the support frame system further comprises an adjustable plate configured to move toward and away from the user. In some embodiments, the support frame system further comprises an arm plate.

According to some variants, a parallel bar apparatus can include at least one tiltable parallel bar connected to a vertical support, the at least one parallel bar movable between a horizontal position and a tilted position. The system can include a latching mechanism that releasably secures the at least one parallel bar in the horizontal position.

In some embodiments, the parallel bar apparatus further comprises a floor deck. In some embodiments, the parallel bar apparatus further comprises an end piece that connects the at least one parallel bar with a second parallel bar.

According to some variants, an ambulatory assistance system can include at least one parallel bar tiltably connected to a vertical support, the at least one parallel bar movable between a horizontal position and a tilted position. The ambulatory assistance system can include a support frame system and a sliding mechanism that connects the support frame system and the at least one parallel bar. The support frame system can include a main body, the main body having an opening. The support frame system can include at least one enclosure arm movable between an open and a closed position relative to the opening, the open position allowing a user to enter the support frame system and the closed position inhibiting the user from exiting the support frame system. In some embodiments, the tilted position of the at least one parallel bar allows a user to access the support frame system from a seated position.

In some embodiments, the ambulatory assistance system further comprises a counter balance. In some embodiments, the ambulatory assistance system further comprises a latching mechanism, the latching mechanism securing the at least one parallel bar in the horizontal position.

According to some variants, an ambulatory assistance system includes at least one vertical support. The ambulatory assistance system can include a support frame system rotatably connected to the at least one vertical support and an automated height adjustment system that adjusts the at least one vertical support to move the support frame system between a horizontal position and a tilted position. The support frame system can be rotatably connected to the at least one vertical support. The support frame system can include a main body, the main body having an opening. In some embodiments, the support frame system includes at least one enclosure arm movable between an open and a closed position relative to the opening, the open position allowing a user to enter the support frame system and the closed position inhibiting the user from exiting the support frame system. In some embodiments, the ambulatory assistance system includes a securing mechanism that secures the at least one enclosure arm in the closed position. In some embodiments, the tilted position of the support frame system allows a user to access the support frame system from a seated position.

### BRIEF DESCRIPTION OF THE DRAWINGS

The disclosed aspects will hereinafter be described in conjunction with the appended drawings, provided to illustrate and not to limit the disclosed aspects, wherein like designations denote like elements. The drawings disclose illustrative embodiments. They do not set forth all embodiments. Other embodiments may be used in addition to or instead. Conversely, some embodiments may be practiced without all of the details that are disclosed. It is to be noted that the figures provided herein are not drawn to any particular proportion or scale, and that many variations can be made to the illustrated embodiments. Certain features, aspects, and advantages of the present invention will now be described with reference to the drawings, in which embodiments are intended to illustrate and not to limit the invention, and in which figures:

FIG. 1 is a front perspective view of an embodiment of an ambulatory assistance system illustrating the individual support frame system in a closed position.

FIG. 2 is a front perspective view of the ambulatory assistance system of FIG. 1, illustrating the individual support frame system in an opened position.

FIG. 3 is a front perspective view of the ambulatory assistance system of FIG. 1, illustrating the parallel bars in a tilted position and the individual support frame system in an opened position;

FIG. 4 is a rear perspective view of the ambulatory assistance system of FIG. 1, illustrating the parallel bars in a tilted position and the individual support frame system in an opened position;

FIG. 5 is a side perspective close up view of the individual support frame system of the ambulatory assistance system of FIG. 1, illustrating the individual support frame system in a closed position;

FIG. 6 is a perspective view illustrating an embodiment of a latching mechanism that secures the parallel bars in a horizontal position;

FIG. 7 is a top plan view illustrating an embodiment of an adjustable frame on the individual support frame system;

FIG. 8 is a front perspective view of an ambulatory assistance system having one or more mobility structures; and

FIG. 9 is a close up perspective view of a latching mechanism configured to releasably maintain the parallel bars in a horizontal position.

### DETAILED DESCRIPTION OF CERTAIN FEATURES

Some embodiments relate to an ambulatory assistance system that includes a set of parallel bars and an individual support frame system. The ambulatory assistance system can increase an individual's independently initiated physical activity and reduce the amount of aid an individual needs while using the system. When using a set of parallel bars, an individual typically needs the most assistance while entering and exiting the parallel bars and when turning around to walk back to the starting position. Aspects of the system enable the individual to require less assistance while entering and exiting the parallel bars and when turning around. The ambulatory assistance system can reduce the amount of training and strength needed by someone to assist the individual with the system. Generally, a trained therapist or caregiver at home assists an individual as the individual is performing prescribed or desired exercises or activities. The individual could be recovering from a medical condition (e.g., stroke, spinal cord injury, leg injury, hip injury, back injury, surgery, coma, athletic injury, loss of muscle (sarcopenia), loss of coordination (ataxia), and the like). The individual could also have a disabling condition with risk of falling like ALS, Parkinson's, multiple sclerosis, cerebral palsy, rheumatoid arthritis, advanced diabetic degenerative conditions, etc., where lack of balance and coordination necessitate use of a wheelchair.

Some embodiments relate to a support frame system, which enables the individual to pull themselves to a standing position from a sitting position and support themselves, maintain balance and reduce the risk of falling. The support frame system, in the tilted position, enables an individual to pull themselves out of a sitting position into a standing position. During this transition, the individual is guided gently forward and protected from falling or swaying off balance. The system can allow the individual to transition from the sitting to standing positions with little or no additional assistance from a caregiver or therapist. An individual can use the support frame system during prescribed or desired exercises and/or other activities, such as, sit-to-stand motion, stand-to-sit motion, standing exercises, sitting exercises, walking, and the like. The support frame system can at least partially or fully surround the individual and help reduce risk of falls in any direction when the enclosure (e.g., the 360 degree enclosure) is secured. This stability provided by the support frame system can allow the individual to focus on the process of walking with less concern for maintaining balance.

The support frame system can have one or more layers. The support frame system can have an upper layer that interacts with the individual's upper extremities (e.g. elbow, forearms, wrists, and hands). The upper layer of the support frame system can have padding. The support frame system can have a middle layer that connects an upper layer and a lower layer. The support frame system can have a lower layer. The lower layer can be shaped so that person can fit inside. The lower layer can have an opening on one side. The lower layer can have a horseshoe like shape. The lower layer can have an interior opening that is shaped for a person to fit inside (e.g. arcuate, elliptical, circular). The lower layer can provide structural support. The lower layer can be attachable to a set of parallel bars. The lower layer can be attachable to vertical support bars, such that the support frame system can be used without a set of parallel bars. In some embodiments, the aspects described can be on one layer or two layers.

The support frame system can be used with a set of parallel bars. In some cases, the support frame system is used as a standalone (e.g., without parallel bars) device. In some cases, the support frame system is used with non-parallel bars or a single bar. The support frame system can be movably supported on the parallel bars. The support frame system can be movably positioned on the upper surface of the parallel bars. The support frame system can move with the individual as the individual moves along the parallel bars. The support frame system can move via a sliding mechanism (e.g., rollers, sliders, wheels, low friction/frictionless surfaces, a caterpillar track, a continuous track, one or more pulleys, and/or some combination thereof). The support frame system can be connected to the parallel bars such that the support frame system is inhibited or prevented from disengaging from the parallel bars. The support frame system can be adjustable for different sizes of parallel bars (e.g., diameter, height, and length of bars and distance between bars). The support frame system can be adjusted to enable the device to accommodate various sizes and types of parallel bars.

As the individual moves along the parallel bars, the support frame system can provide extra support, for example, when the individual has difficulty supporting his or her own weight or maintaining balance. The support frame system can provide support in the vertical direction and can help prevent the individual from tilting while using the support frame system. The support frame system can have padding on the upper surface. The support frame system can have padding on the interior surface. The individual's weight can be distributed to their skeletal structure via his or her elbows positioned on an upper surface of the support frame system in an ergonomically comfortable fashion. For improved support, comfort, and ease, the individual's elbows can be positioned directly below the individual's shoulders. This positioning can reduce unnecessary energy expense in balancing body structure and/or weight. This can enable more of the individual's energy to be directed toward taking steps.

The support frame system can help reduce the risk of the individual falling in various directions. For example, the individual can be protected from falling in any direction (e.g., including forwards, backwards, or sideways) due to the support frame system surrounding the individual 360 degrees. The support frame system can be configured to hold the upper body weight of the individual in a limited range of uprightness such that regaining balance is achievable by a person, even in a diminished strength condition. The support frame system can have an interior arcuate surface to receive the individual's abdomen and or torso region. The front and rear portions of the interior surface can be arcuate to receive the individual's abdomen when the individual turns in the support frame system and walks in the opposite direction.

The support frame system could also have a brake mechanism to resist movement of the support frame system along the length of the parallel bars. This could aid the individual in doing stationary exercises. This could aid the individual if they need or desire to rest during use. This could be used while the individual enters and exits the support frame system.

The support frame system can be adjustable for different sizes of individuals. The support frame system can have width adjustable arm rests. The support frame system can be come in different sizes to accommodate the various sizes and shapes of people. The support frame system can be sized to accommodate children.

Some embodiments relate to an ambulatory assistance system that can be used with little to no structural impact on the home, hospital, nursing home, therapy center, or the like. The system, apparatus, and devices can be used with little or no attachment to walls, floor, or ceiling. The system, apparatus, and devices can be free standing, such that there is no permanent attachment to the walls, floor, or ceiling. Because the system, apparatus, and devices can be free standing, there is little to no structural impact on the room where it is used. This aspect can reduce the cost of installation and removal of the system.

In some embodiments, the system, apparatus, and devices can be mobile and portable, for example, having leveling casters, wheels, sliders, or the like. The leveling casters, wheels, sliders, or the like can be connected to the vertical supports of the parallel bars, by a structurally stable gusseted base frame, directly to the parallel bars, to the support frame system, or another component. The leveling casters, wheels, sliders, or the like can be removable.

The system, apparatus, and devices can have a stabilizing system, for example, leveling casters, floor locks, locking wheels, supporting legs, kickstand, or the like to prevent unwanted movement of the system, apparatus, and devices while in use. The stabilizing system can be connected to the vertical supports of the parallel bars, directly to the parallel bars, to the support frame system, or another component. In some embodiments, the stabilizing system is connected to the vertical supports by a base frame (e.g., a gusseted base frame). The stabilizing system can be removable. This aspect can reduce the cost of installation and removal of the system and increase flexibility and the ease of use.

In some embodiments, the length of the parallel bars and/or vertical supports can be telescoping and collapsible. In some embodiments, the support frame system can be collapsible. This aspect can accommodate storage in smaller spaces, saving cost and enabling ease of use in smaller homes or facilities.

Some embodiments relate to an ambulatory assistance system with tiltable parallel bars. The parallel bars can be tiltable between a horizontal position and an angled position where one end of the parallel bars is lowered and the opposite end of the parallel bars is raised. The parallel bars can be tilted via a hinge, ball and socket joint, or the like. The parallel bars can be connected to vertical supports via a hinge, ball and socket joint, or the like. The parallel bars can be tilted via changing the height of the vertical supports. The height of the vertical supports can be independently adjustable so that one end of the parallel bars is lowered moving the parallel bars into a tilted position. The adjustment of the vertical supports can be automated via a suitable mechanism for controlling height (e.g., pneumatics, air cylinders, electric screws, linear actuators, hydraulics, etc.). In some embodiments, the user or caregiver can control the speed at which the vertical supports change height. The speed can be increased or decreased according to individual need or caregiver control. The adjustment of the vertical supports can be controlled with adjustable levers, buttons, or the like. There can be a controller that communicates with the vertical supports to control the height of the vertical support(s), speed of adjustment, and angle of the parallel bars. The parallel bars can have vertical supports at or near each end. In some such cases, the bars do not have a hinge and/or other support between the two or more sets of vertical supports near or at the ends of the parallel bars. The parallel bars can be independently movable. The parallel bars motion can be coordinated so that the parallel bars move in accord with each other. The length of the parallel bars can be up to any functionally feasible length. For example, the length can be up to 10 feet, up to 15 feet, up to 20 feet, up to 22 feet, up to 40 feet, and/or any length therebetween. In some cases, the length of the parallel bars is greater than 40 feet. In some embodiments, the length of the parallel bars can be between 3 feet and 4 feet, which would be useful in places with space restrictions like the home. The length of the parallel bars can be adjusted via a telescoping structure to accommodate a variety of room space limits. The length of the parallel bars can vary for both automated and non-automated systems. In some embodiments, the frame of the device is directly connected to a plurality of adjustable-height (e.g., automatically adjustable) vertical supports. In some such cases, the frame is used separate from (e.g., without) bars or other support structures.

In some embodiments the height of the vertical supports may be automated (e.g., controlled by a controller, by a sensor, and/or by voice command). In some embodiments where height adjustment is automated, the latching mechanism may not be needed as the height of the vertical supports will be fixed according to the height at which they are adjusted.

In automated embodiments the height adjustments of the vertical supports can execute the tilting of the parallel bars and the lift-assist of the individual to stand from the sitting position.

The tiltable aspect of the parallel bars can assist an individual in performing sit-to-stand and stand-to-sit exercises (both motions can be referred to as sit-to-stand). The individual can access the parallel bars or a support frame system on the parallel bars from a seated position (e.g., wheelchair, seat, or bed) when the end of the parallel bars is lowered. As the individual stands, his or her end of the parallel bars rises. The tiltable parallel bars can assist the individual in the sit-to-stand motion via a counter balance mechanism. The counter balance can be used as a lift assist during the sit-to-stand motion. The individual can perform this motion with little to no assistance from a caregiver or therapist. This can empower the individual to initiate more independent activity.

Once the individual is in a standing position, the parallel bars can be secured/adjusted (e.g., manually or automatically) in a horizontal position. The parallel bars can be connected to a weight on the latch end to counteract the weight of the individual on the other end of the parallel bars. The parallel bars can be secured by at least one latching mechanism. The latching mechanism can be self-locking, such that it automatically locks without manual assistance. The latching mechanism can be released locally or remotely. A remote release allows the individual or therapist to release the latching mechanism from the opposite end of the parallel bars, where the individual's wheelchair is. In some embodiments, where the height adjustment of the vertical supports is automated, the parallel bars can be secured in a horizontal position by securing the height of the vertical supports. The user or caregiver can remotely control the adjustment of the vertical support and at what height the vertical supports are secured.

The individual can exit the parallel bars and/or support frame system in a manner similar to the way the individual entered. When the latch is released, as the individual sits, his or her end of the parallel bar lowers. The tiltable parallel bars can assist the individual in the stand-to-sit motion, guiding the individual squarely into a seated position, stabilizing them from leaning disproportionately in any direction. A counter balance mechanism (e.g., on the latch end of the parallel bars) could be employed should the length and weight of the parallel bars on shorter models be insufficient to prevent the individual from landing forcefully into the chair during the stand-to-sit motion. The individual can perform this motion with little to no assistance from a caregiver or therapist. This can facilitate greater independence in the individual.

Some embodiments relate to an ambulatory assistance system without parallel bars. For example, the support frame system can be hinged atop vertical support bars.

Aspects of the system, apparatus, devices, and methods can be used for various activities besides walking. Aspects of the system, apparatus, devices, and methods can be combined with conventional therapies and/or activities. Especially in the home setting, an individual may want to perform a multitude of activities in a strong stable structure that reduces the fear of falling. The individual can stand in place and utilize an optional activity frame, utilize optional overhead occupational therapy devices, pedal an optional stationary bike, step up and down on an optional step(s), use an optional treadmill, use an optional commode unit, etc. The exercises can be part of a rehabilitation program or exercise program. The exercises can be part of normal daily activities. The individual can execute the sit-to-stand exercise from a wheelchair, being supported and protected from falling, while the caregiver removes the wheelchair and replaces it with a commode unit to assist with elimination needs. The individual can execute the stand-to-sit exercise and sit on the commode unit. Utilizing the sit-to-stand assistance of the system can be especially helpful in homes where toilets are located in tight or otherwise difficult to access locations and in situations where the individual is larger than the individual's caregiver.

There can be an optional frame top activity tray so that the individual can perform desired activities standing as opposed to sitting in a wheelchair. For example, the frame can be configured to be used in conjunction with and easel, a computer, an electronic tablet, or other activity structure or mechanism. The individual can stand during recreational activities, exercise and/or occupational therapies and be protected from falling. In some configurations, the individual can release floor locks or other locks and use the system as a walker with 360 degree fall protection.

There can be an optional overhead activity bar for upper body strength activities and/or occupational therapies.

There can be an optional stair step block with at least one level so that the individual can step up and down.

There can be an optional bike seat and pedals. The pedals can have a resistance adjustment.

There can be a leg press and/or various strength training accessories that would normally be found in a gym or rehabilitation training center.

There can be an optional treadmill apparatus that enables the individual to walk, jog, and/or run further and without fear of falling—this feature could be valuable for any elderly person wanting to exercise on such an apparatus without the fear of falling off the unit. There can be an optional treadmill that can rest on the floor of the unit or can be the floor of the unit. The treadmill can be activated according to the foot movement of the individual to remain in the pace range of the individual, which is generally slow. The treadmill can have the tread surface tilt to give the individual a hill climbing experience. The tread surface can tilt incrementally to an incline desired by the individual or therapist. Walking on an inclined surface can increase the leg lift used by the individual. There can be an optional upper frame for use with the treadmill that allows swivel and swing motion of the user, replicating a natural walking motion with torso twisting and arm swing. The optional upper frame can have arm cradles or handles that assist with the swivel and/or swing motions.

There can be handles extending vertically from the support frame system and positioned adjacent to the forward (e.g., entrance) end of the support frame. There can be cutouts (e.g., holes and/or indentations) in the support frame system for the individual to hold onto and/or into which the individual can direct one or more fingers, a wrist, a palm, and/or an elbow. In some configurations, grips (e.g., ergonomic grips), cutouts, and/or other structures can be used to allow the individual to hold onto the support frame system. These structures can allow an individual with diminished grip strength or with one or more partially or fully missing or non-functional digits to grip the support frame system. The cutouts can be included in addition to or instead of the handles or grips. The handles, grips, and/or cutouts can be positioned so that the individual can rest her or his arms on the upper surface of the support frame system while grasping the handles and/or cutouts. There can be handles and/or cutouts positioned adjacent the rear (e.g., latch) end of the support frame system so that they will be in a forward position when the individual turns in the support frame system to return to the starting position. The position of the handles, grips, and/or cutouts can be adjustable. The size (e.g., height, diameter, cross-sectional shape, width) of the handles, grips, and/or cutouts can be configured to work with the needs of the individual. The shape of the handles, grips, and/or cutouts can be ergonomic. In some embodiments, one or more slots extend at least partially through a portion of the support frame system to allow for insertion of the individual's hand(s). In some embodiments, one or more bands extend from the support frame system to attach to the individual's wrist.

The position of the handles, grips, and/or cutouts can allow the individual to walk sideways, such that the individual is facing one of the parallel bars and is moving sideways along the length of the parallel bars. For example, the individual could grasp a front handle, grip, and/or cutout and a rear handle, grip, and/or cutout and walk sideways from one end of the parallel bars to the other end. The individual can change positions and grip configuration throughout the rehabilitation without needing to alter the support frame system. The individual can walk forwards, backwards, and sideways all during one trip (from one end of the parallel bars to the other) because the individual is able to turn at any point along the parallel bars in the support frame system. The individual is able to turn up to 360 degrees while in the support frame system. Sideways walking can include variations of lateral shuffling/side stepping (sideways movement where feet do not cross each other) or grapevine (feet cross each other). Walking can include knee marching/high knees, heel to toe, or other prescribed or desired exercises or activities.

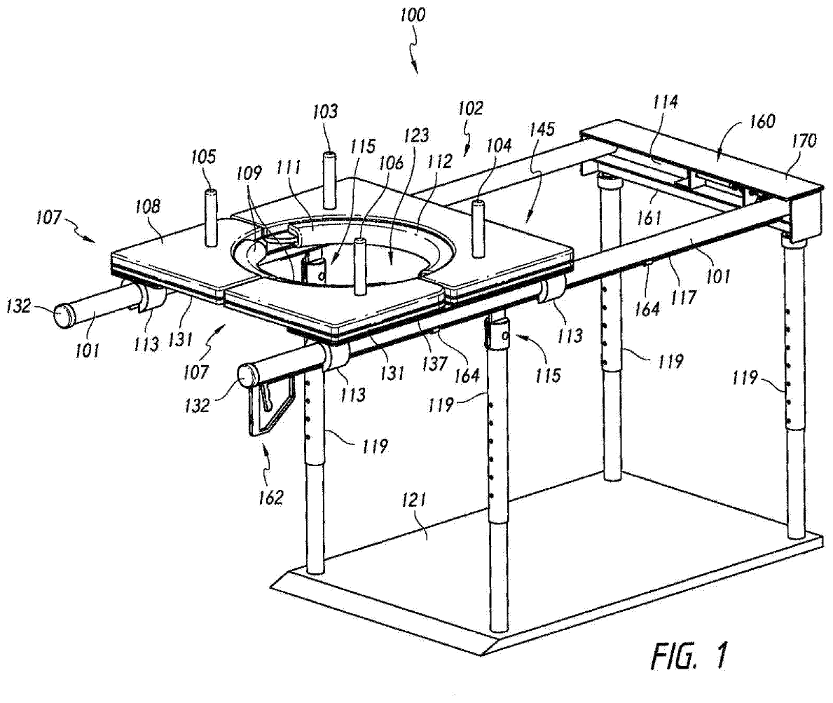

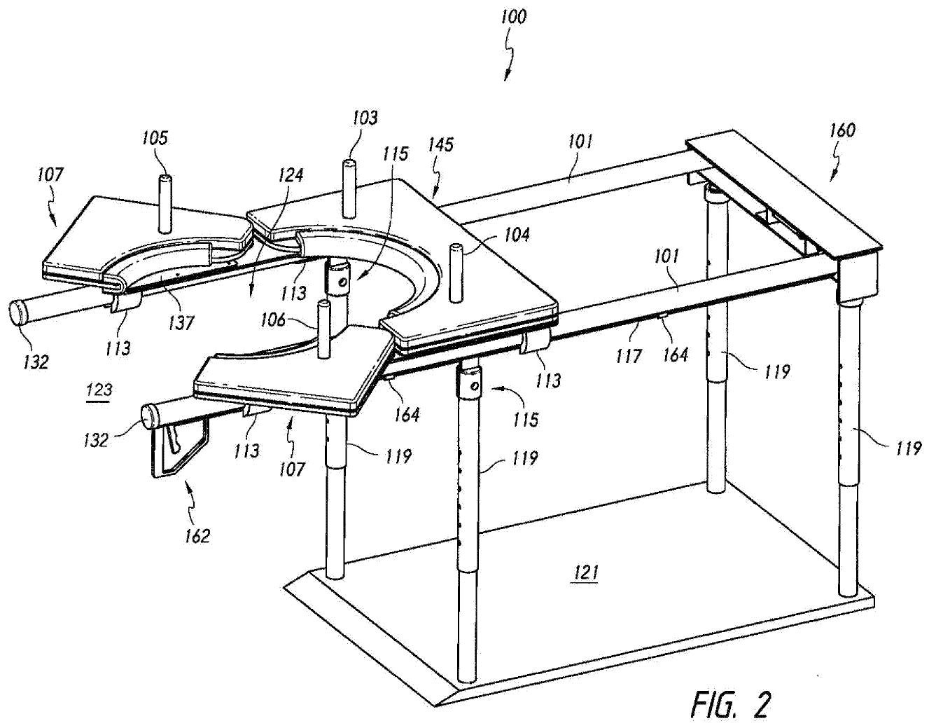

FIGS. 1-5 illustrate an embodiment of an ambulatory assistance system 100. The ambulatory assistance system 100 can include a set of parallel bars 101. The ambulatory assistance system 100 can include a support frame system 102. FIGS. 1-5 illustrate an embodiment of the support frame system 102. The support frame system 102 can at least partially surround the individual. In some cases, the support frame system 102 can completely surround the individual. The support frame system 102 can have one or more layers. The support frame system 102 can help prevent the individual from falling. The support frame system 102 can include a main body 145. The support frame system 102 can have at least one enclosure arm 107 that is movable between open and closed positions. In the open position (FIGS. 2-4), the enclosure arms 107 allow the individual to enter the support frame system 102 (e.g., to enter the support frame system 102 from a lateral or vertical direction). In the closed position, the enclosure arm 107 can connect with the main body 145 of the support frame system 102 and can enclose the individual safely inside. The main body 145 of the frame 102 can have a shape like a horseshoe, “U”, semi-circular, semi-elliptical, or the like. There can be a securing mechanism that secures the enclosure arm 107 in the closed position. The securing mechanism can be, for example, a latch, a clip, hook-and-loop fasteners, magnets, detents, a hook and eye latch, one or more springs, and/or some other securing mechanism or plurality of mechanisms. In some embodiments, the enclosure arms 107 are biased to the closed position (e.g., by a spring or other biasing mechanism) and will automatically transition to the closed position after an individual enters the frame system 102. In some embodiments, one or more of the enclosure arms 107 can be positioned in the closed position without use of a securing mechanism (e.g., one or more of the enclosure arms can be movable via electromechanical control).

As illustrated in FIG. 1, the support frame system 102 can have two enclosure arms 107, a left and a right enclosure arm. The enclosure arms 107 can be rotatable about a vertical axis. FIG. 2 shows the enclosure arms 107 in an open position. The enclosure arms 107 can have one or more layers. The enclosure arms 107 can have an upper padding 108 that can help cushion pressure points, support the individual, and/or increase height of the frame system 102. The enclosure arms 107 can have a lower layer 131. The lower layer 131 can be coupled with an interior padding 109 that can help protect the individual when he or she leans against the inside of the frame, becomes weakened, trips, loses balance, and/or begins to fall. The enclosure arms 107 can be mounted on a guided track extending perpendicular to the direction of the parallel bars 101. Mounting the enclosure arms 107 on such a guided track can decrease clearance needs for using the support frame system 102.

The support frame system 102 can have an upper padding 110 to help cushion pressure points, support the individual, and/or increase height on non-automated embodiments. The support frame system 102 can have an interior padding 111 that can help protect the individual when they lean against the frame, either from normal use or from a trip or loss of balance. The padding on the support frame system 102 and/or enclosure arms 107 can be made from foam, rubber, plastic, or another suitable material.

In some embodiments, the support frame system 102 includes one or more additional layers for the main body portion 145 and/or the arm(s) 107. For example, the arms 107 main include an upper layer positioned between the lower layer 131 and the padding 108. When in a closed position, the lower layers 131 of the right and left enclosure arms 107 can help enclose the individual generally 360 degrees, as illustrated in FIG. 2. When in a closed position, in some embodiments, the upper and/or lower layers 131 of the right and left enclosure arms 107 can come together and help enclose the individual generally 360 degrees. In some embodiments, when in a closed position, one or more layers of the right and left enclosure arms 107 do not come together such that upper padding 108 and 110 extends less than 360 degrees around the individual.

The enclosure arms 107 can have multiple layers. The main body 145 of the support frame system 102 can have multiple layers. The support frame system 102 and enclosure arms 107 can be placed on separate layers. The support frame system 102 and enclosure arms 107 can be placed on the same layer. The support frame system 102 can have an interior cutout 112. The cutout 112 can be any shape that accommodates the individual's torso, for example, arcuate, ergonomic, elliptical, semi-circular, or the like. The interior surface of the enclosure arms 107 can have a shape that accommodates the individual's torso. The individual may lose their balance and fall backward/sideways, forward on the interior surface of the enclosure arms 107 or when walking, the individual may lean forward/sideways on the interior surface of the enclosure arms 107. The interior surface of the enclosure arms 107 may be arcuate, ergonomic, elliptical, circular, or the like. Since the individual can turn 360 degrees in the support frame system 102, the front, back, or side of the individual can interact with the interior surfaces of the enclosure arms 107 and support frame system 102.

The support frame system 102 can rest on parallel bars 101. The support frame system 102 can move along the parallel bars 101 via a sliding mechanism 113. The sliding mechanism 113 can be a surface with little to no friction, for example, a roller, slider, wheels, or the like. The sliding mechanism 113 can secure the support frame system 102 to the parallel bars 101 such that the frame 102 cannot be lifted off the parallel bars 101 during use. In some embodiments, all or a portion of the sliding mechanisms 113 are constructed from a low-friction material. The bars 101 can be constructed from a low-friction material.

FIG. 1 illustrates the parallel bars 101 in a secured horizontal position. There can be a frame or single post or set of height adjustable vertical supports 119 that helps secure the position of the parallel bars. The parallel bars 101 can be supported by the vertical supports 119. The supports 119 can be adjustable, such that the length of the vertical supports 119 can be adjusted. Adjusting the length of the vertical supports 119 can allow the parallel bars 101 to be adjusted for different heights of individuals. The vertical supports 119 can be free standing. For example, each of the vertical supports 119 can be connected to one or more other supports via brackets, braces, side walls, and/or other stabilizing structures without being fixedly attached to the ground or to a system floor.

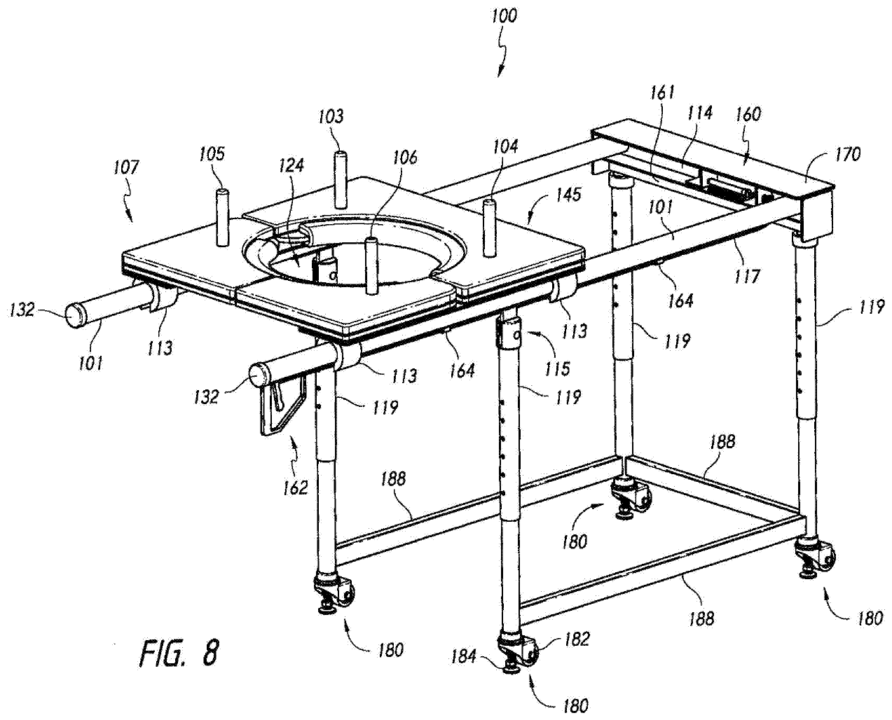

In some embodiments, the vertical supports 119 can be connected to a floor structure 121. The floor structure 121 can be a flat surface for the individual to walk on. The floor structure 121 can be smooth to reduce the risk of tripping by the individual. The floor structure 121 can be changed to meet the needs of the individual and his or her exercises. For example, various floor structures having various features (e.g., steps, step pacing brackets, a treadmill, slopes, high-friction surfaces, and/or some combination thereof) can be interchanged with the illustrated flat floor structure 121. Interchanging can be achieved via a fastened connection, a friction-fit connection, magnetic connection, and/or some connection structure or combination of structures. The unit can be used without a floor structure 121. In those instances, the individual can walk on whatever surface is in the home, therapy center, or the like. In some embodiments, the floor structure 121 can provide stability to the vertical supports 119 to reduce the risk of tilting or sliding of the vertical supports 119. In some embodiments (see, e.g., FIG. 8), one or more braces, gussets, or other stabilizing structures may be used instead of or in addition to the floor structure 121 to connect one or more of the vertical supports 119 to one or more other vertical supports 119 to provide structural stability.

The parallel bars 101 can have an end piece 114 that connects the two parallel bars 101. In some embodiments, the parallel bars 101 do not have an end piece 114 and both ends of the parallel bars 101 are open. In some embodiments, wherein the height adjustment of the vertical supports is automated, there might be no latching mechanism needed.

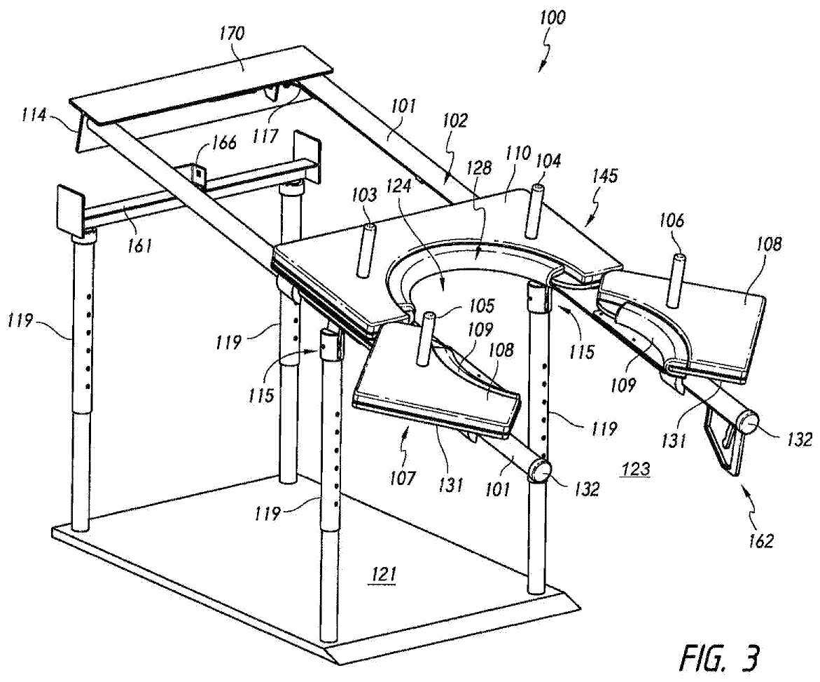

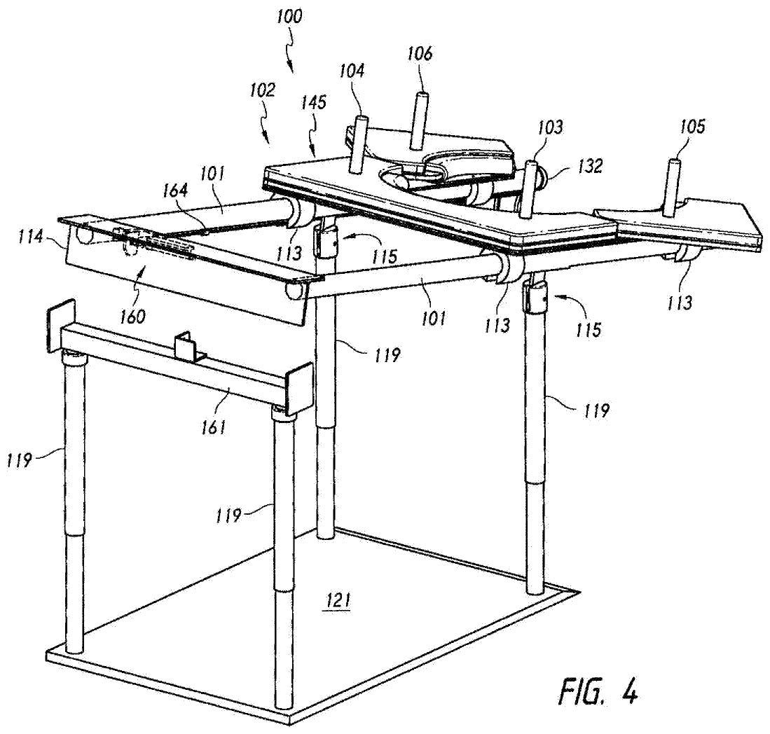

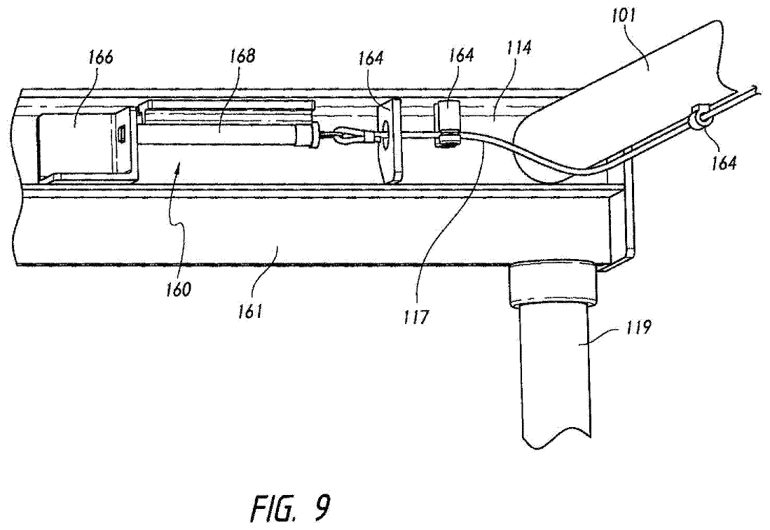

As best illustrated in FIGS. 1 and 9, the system 100 can include a latch system 160 (e.g., a latching mechanism). The latch system 160 can be configured to releasably connect the parallel bars 101 to the vertical supports 119. The system 100 can include a release mechanism 162. The release mechanism 162 can be configured to facilitate release of the latch system 160. In some embodiments, the system 100 includes more than one releasing mechanism. Additional releasing mechanisms can be positioned at various positions on the bars 101, the support frame system 102, the latch system 160, and/or elsewhere in the system 100. Including additional releasing mechanisms can facilitate easier use for a care provider or for the individual user. Releasing the latch system 160 can allow the parallel bars 101 to tilt about one or more of the vertical supports 119 (see, e.g., FIGS. 3-4). The releasing mechanism 162 can be a lever, a knob, a switch, a trigger (illustrated), a pull-cord, or some other mechanism. The releasing mechanism 162 can be positioned at or near an end of the system opposite the latch system 160. For example, the releasing mechanism 162 can be positioned at or near an end of one of the parallel bars 101 opposite the end piece 114. The releasing mechanism 162 can be connected to the latch system 160 via a cable 117. The cable 117 can run along one or more of the parallel bars 101. In some embodiments, one or more cable guides 164 are used to guide the cable 117 between the releasing mechanism 162 and the latch system 160. In some case, the cable 117 extends through at least a portion of the interior of one or more of the parallel bars 101.

Referring to FIG. 9, the latch system 160 can include a fixed portion mounted to a transverse portion 161 connecting the two vertical supports 119 furthest from the entrance end of the parallel bars 101. For example, a bracket 166 may be mounted to the end piece 114. A pin 168 or other movable structure may be configured to engage the bracket 116 to maintain the latch system 160 in the locked position illustrated in FIGS. 1 and 9. In some embodiments, the pin 168 is spring loaded or otherwise biased to an engaged position. In some embodiments, the bracket 166 is movable and the pin 168 is fixed. As illustrated, the movable portion (e.g., the pin 168 in the illustrated embodiment) can be mounted on the end piece 114. The latch system 160 can be configured such that actuation of the releasing mechanism 162 moves the pin 168 out of engagement with the bracket 166. Disengagement of the pin 168 from the bracket 168 can allow the parallel bars 101 to transition to the tilted position illustrated in FIGS. 3-4. In some embodiments, the pin 168 and/or bracket 166 can include a sloped portion or other structure configured to facilitate automatic engagement between the pin 168 and the bracket 166 when the parallel bars 101 are lowered to the level or untilted position. The system 100 can include a latch cover 170. The latch cover 170 can be a plate, bar, tube, or other structure that extends over a top side of the latch system 160. The latch cover 170 can reduce the risk of inadvertent impact on the latch system 160.

As illustrated in FIG. 3, the individual can enter the support frame system 102 and grasp handles 103 and 104. For example, the individual could position her or his wheelchair directly in front of the support frame system 102. The individual, or the care provider, can actuate the releasing mechanism 162 to disengage the latch system 160. The individual or care provider can tilt the parallel bars 101 such that the support frame system 102 is lowered. The individual or care provider can open the enclosure arms 107, as illustrated in FIGS. 2-4 either before or after tilting the bars 101. As illustrated in FIG. 3, the support frame system 102 can have an opening 123 where the individual can enter. As illustrated in FIG. 3, the enclosure arms 107 can be in an open position that can create the opening 123. As illustrated in FIG. 2, the enclosure arm handles 105 and 106 can be located on enclosure arms 107 and forward handles 103 and 104 can be located on the main body 145 of the support frame system 102. The handles can be positioned in locations that are convenient for the individual to grasp while walking, going from a sitting to a standing position and vice versa. The individual's body can fit in the interior part 124 of the frame 102. The main part of the support frame system 102 and the enclosure arms 107 create the interior part 124. The interior part 124 can have a shape that is generally arcuate, ergonomic, elliptical, circular, or the like. When the individual is inside the interior part 124, the parallel bars 101 can be tilted back to reengage the latch system 160. Once insider the interior part 124 of the support frame system 102, the individual can walk forwards towards the opposite (e.g., latch) end.

As illustrated in FIG. 3, the enclosure arms 107 can have one or more layers. There can be a lower layer 131 that can help secure the individual's torso. The lower layer 131 can have interior padding 109. The lower layer 131 and/or an upper layer can include an upper padding 108. In some instances, layers of the arms 107 can move independent of each other.

In some embodiments, the support frame system 102 can include a lower frame layer 137. The lower frame layer 137 can be connected to the sliding mechanism 113. In some embodiments, the lower frame layer 137 extends below the main body 145 of the support frame system 102 and can have a continuous horseshoe shape that extends beneath both enclosure arms 107.

As illustrated in FIG. 3, there can be a stopper, end cap or the like 132 on or adjacent to the end of the parallel bars 101 that can inhibit or prevent the support frame system 102 from inadvertently sliding off the parallel bars 101.

There can be a ramp at an end of the floor 121 adjacent the entrance end of the parallel bars 101. The ramp can make it easier for the individual to move his or her wheelchair into the proper position. In some cases, the ramp makes it easier for the individual to enter the floor structure 121. Once the individual is in the proper position, the individual, with the optional assistance of a caregiver or therapist can lower the frame 102. With the support frame system 102 tilted into a lowered position, as illustrated in FIGS. 3-4, the individual can lean up into the support frame system 102 and use the cutouts, and/or handles to grasp so as to assist him or her with the sit-to-stand motion as the individual shifts his or her weight forward, lifting their body with their legs and moving the bars 101 return to a horizontal position to reengage the latch system 160. As illustrated in FIGS. 3-4, when the support frame system 102 is on the lowered end of the tilted parallel bars 101, the latch end of the parallel bars 101 (e.g., end piece 114) is in a raised position.

The parallel bars 101 can be movable about one or more hinges 115. In some embodiments, the hinges 115 can be ball and socket joints or other mechanism that allows the parallel bars to tilt or rotate at an angle with respect to horizontal. The hinges 115 can be connected to one or more of the vertical supports 119. In some embodiments, wherein the system 100 includes four vertical supports 119, each of the supports 119 is connected to one or both of the parallel bars 101 via a hinge 115. The hinges 115 can be located along the lengths of the parallel bars 101. One or more of the hinges 115 can be located about the middle of the lengths of the parallel bars 101. The hinges 115 can be located closer to the entrance of the parallel bars 101 (e.g., ramp 125). The hinge 115 can be located closer to the latch end of the parallel bars 101 (e.g., end piece 114). The hinge 115 allows the parallel bars 101 to be tilted at an angle with respect to horizontal. As illustrated in FIGS. 3-4, the latch end 114 of the parallel bars 101 is in a raised position as the entrance end of the parallel bars 101 is in a lowered position. In some embodiments, tilting of the bars 101 can be actuated by lengthening one or more of the vertical supports 119 and/or shortening one or more of the vertical supports 119. For example, the supports 119 nearest the entrance of the parallel bars 101 can be lowered while the supports 119 furthest from the entrance are raised. This can be realized via hydraulic, electronic, pneumatic, or other force applied to shorten/lengthen one more of the vertical supports 119.

The individual can more easily access the support frame system 102 from a sitting position when the entrance end is in a lowered position and from there the individual can work on the sit-to-stand exercise with little to no assistance from a therapist or caregiver. The individual can grasp the support frame system 102, its cutouts, grips, or handles 103 and 104 as the individual is sitting at the entrance. As the individual moves from sitting to standing, the entrance end of the parallel bars 101 rises towards a horizontal position. In some embodiments, the transition of the parallel bars 101 toward the horizontal position is aided by hydraulic, electronic, pneumatic, or other force applied to shorten/lengthen one more of the vertical supports 119.

Once standing, the individual's torso can fit in the interior part 124 of the support frame system 102. The enclosure arms 107 can be moved to a closed position and secured, securing the individual in the support frame system 102. FIG. 1 illustrates an embodiment of the support frame system 102 with enclosure arms 107 (e.g., the lower layer 131) in a closed position. FIG. 1 also illustrates the parallel bars 101 in a secured horizontal position.

The individual can grasp grips or handles 103 and 104 as he or she walks towards the latch end. The support frame system 102 can have an arcuate cutout 128 to accommodate the body of the individual. The support frame system 102 can have an arcuate cutout 129 that is formed when the enclosure arms 107 are in a closed position. There can be different sizes of the support frame system 102 to accommodate the different sizes of individuals (e.g., girth, shape, height). The support frame system 102 can be sized down to accommodate children. The support frame system 102 can have a circumferential frame that at least partially surrounds the individual. In some embodiments, the circumferential frame surrounds the individual about 360 degrees. In some embodiments, the circumferential frame surrounds the individual up to about 360 degrees, about 90 degrees, about 180 degrees, or about 270 degrees.

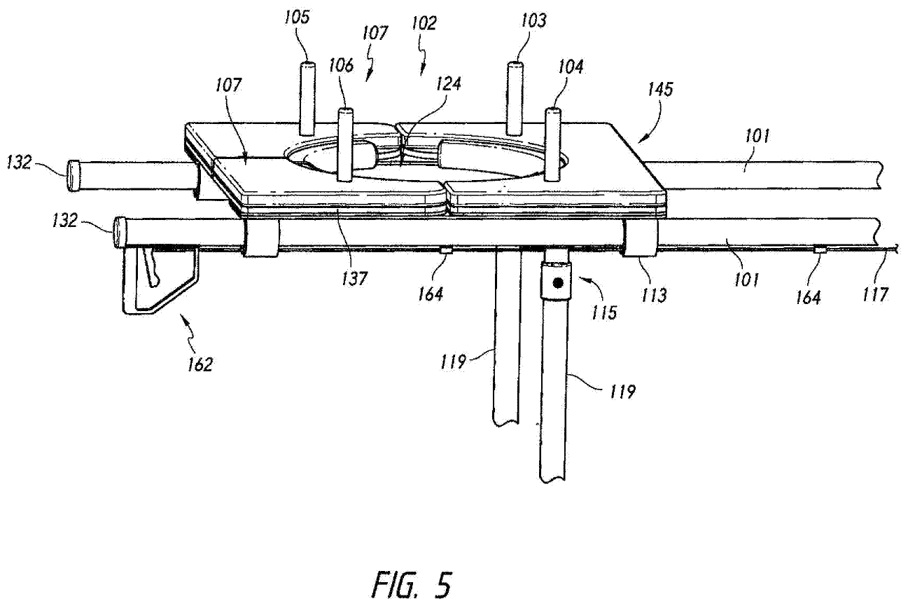

As illustrated in FIG. 5, the support frame system 102 can have at least one grip or handle. In the illustrated embodiment, the support frame system 102 can have four grips or handles. In some embodiments, the support frame system 102 can have no handles. In some embodiments, the frame can have cut-outs (e.g., holes and/or indentations) for the individual to grasp the frame (especially if individual is physiologically unable to grasp a 1¼″ handle—e.g., Rheumatoid arthritis, or lack of opposing thumbs and/or short or shortened digits, or inability to rotate wrist, etc.). The individual has the ability to turn up to 360 degrees and can use the grips and/or handles if needed or wanted. The support frame system 102 can have grips and/or handles on four corners of the support frame system 102. The support frame system 102 can have grips and/or handles positioned anywhere needed for individuals without hands or fingers, etc. The grips and/or handles can be about 90 degrees apart. There can be additional grips and/or handles if needed based on the individual's ability and/or needs (e.g., reach, strength, dexterity, flexibility, coordination). The grips and/or handles can be placed 5, 10, 15, 20, 30, 45, 60, 90, 110, 135, 180 degrees apart. In some embodiments, the grips and/or handles are placed apart at a distance between the above-recited values (e.g., 13 degrees, 51 degrees, 112 degrees, 153 degrees, or some other distance). The grips and/or handles can be placed up to 180 degrees apart. For example, the individual can use the grips and/or handles to make a 180 degree turn to walk back to the entrance with no assistance from a therapist or caregiver.

FIG. 5 shows an embodiment of the support frame system 102 with the enclosure arms 107 in a closed position. The individual can stand in the interior area 124. The interior area 124 is sized so that the individual can turn while also providing security for the individual. Referring to FIG. 5, the individual can grasp handles 103 and 104 and walk forwards towards the right. Alternatively, the individual can turn 180 degrees grasp handles 105 and 106 and walk backwards towards the left. Alternatively, the individual can grasp handles 103 and 105 and walk sideways left and right. The support frame system 102 can be used without the handles 103, 104, 105, and 106. For example, the support frame system 102 can be used with cut-outs for finger holds, slotted 3D structures, and/or other gripping structures.

The support frame system 102 allows the individual to turn around at any point along the parallel bars 101 while using the unit. As such, once the individual reaches an end of the parallel bars 101, the individual can turn around in the support frame system 102 and walk towards the other end of the parallel bars 101. The individual can continue walking laps with his or her exercises without the need of assistance whenever the individual gets to an end of the parallel bars.

The individual can grasp different handles, gripping structures, and/or cutouts, depending on the direction they are walking and the type of walking they are doing. The individual can walk forwards, backwards, and sideways while in the support frame system to exercise different muscle groups, all while being protected from falling and with little assistance from a therapist or caregiver. For example, the individual can walk from the entrance of the parallel bars to the latch end facing forwards and then use the same handles (or cut-outs) and walk from the latch end to the entrance walking backwards. The individual can walk from the entrance to the latch end facing forwards, turn around, and use the handles (or cut-outs) on the enclosure arms and return to the entrance walking forwards. The individual can walk sideways using handles (or finger cut-outs) on the left side, turn around, and can return to the starting position by using handles (or finger cut-outs) on the opposite side and walking sideways.

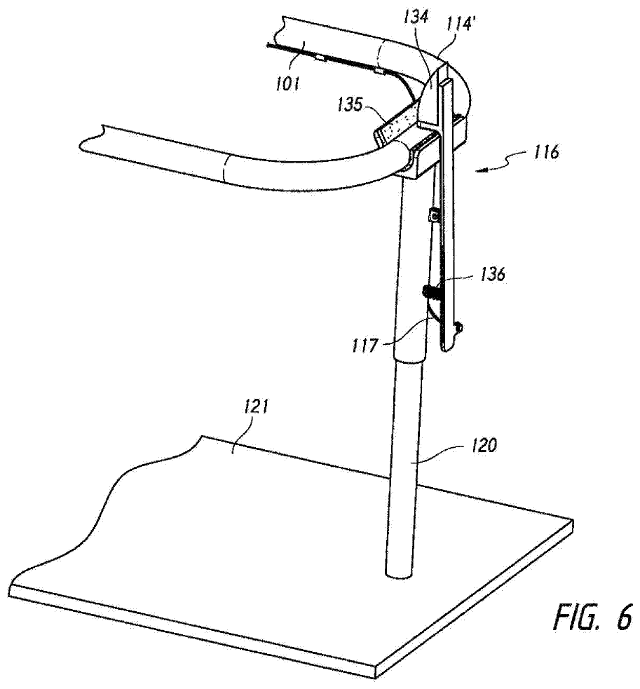

As illustrated in FIG. 6, the system 100 (not shown) can optionally include a latching mechanism 116 separate from the paired vertical supports 119. The latching mechanism 116 can be used in addition to or instead of a second pair of vertical supports 119. The latching mechanism 116 can include a latch base (e.g., one or more legs, platforms, and/or other stabilizing structures) and a vertical support 120 connected to the latch base. In some embodiments, as illustrated, the latching mechanism 116 can be connected to the floor structure 121 in a manner similar to or the same as the vertical supports 119. As illustrated, the latching mechanism 116 can secure the parallel bars 101 (e.g., in a horizontal position). The latching mechanism 116 can secure an end portion 114′. The end portion 114′ can be substantially structurally the same as the end portion 114 described above. In some embodiments, the end portion 114′ is constructed from a portion of tubing formed from bending the parallel bars 101.

The latching mechanism 116 can have a securing portion 134 that secures the end portion 114′ into place. The end portion 114′ can rest on a supporting portion 135. The supporting portion 135 can have a wall/guide that helps catch the end portion 114′ and can help guide the end portion 114′ into the secured position. The securing portion 134 can be moveable (e.g., via a hinge). A biasing member (e.g., a spring 136) can bias the securing portion 134 to the closed or secured position illustrated in FIG. 6. As illustrated, the securing portion 134 can have a sloped surface (e.g., a curved sloped surface) that can cam the securing portion away from the supporting portion 135 when the end portion 114′ transitions into the supporting portion 135. The sloped surface can be formed as an integral part with the remainder of the securing portion 134 or can be formed as a separate part connected to another component of the securing portion 134. One or both of the supporting portion 135 and the securing portion 134 can be constructed at least partially from a flexible, resilient, malleable, soft, padded, and/or compressible material to reduce noise and shock associated with moving the end portion 114′ into the supporting portion 135. The latching mechanism 116 can be released remotely such that the individual or caregiver can release the latching mechanism 116 from the entrance of the unit 100. For example, a releasing mechanism similar or the same as the releasing mechanism 162 discussed above can be used to release the latching mechanism 116. The latching mechanism 116 can be supported by a vertical support 120. The vertical support 120 can be adjustable manually or automated such that the height of the latching mechanism 116 and/or support portion 135 is adjustable. The vertical support 120 can be adjustable such that the height of the supporting portion 135 is adjustable. The latching mechanism 116 can be located adjacent to the hinge 115. The latching mechanism 116 can be located adjacent an end of the parallel bars 101. In some embodiments, the system 100 includes more than one latching mechanism 116 (e.g., one latching mechanism 116 per bar 101).

There can be a limiting mechanism 133 (e.g. limiting line or an adjustably bracketed stopper or limiter at the vertical supports nearest the entrance end), that can limit the motion of the parallel bars 101 when desired. For example, the limiting mechanism 133 can prevent the entrance end of the parallel bars 101 from going too low such that the support frame system 102 would hit the individual when he or she was seated. In some embodiments, the limiting mechanism 133 is releasable from the parallel bars 101 and/or from another component of the system 100.

There can be an optional counter balance accessory on the latch end area that aids (e.g., adjustably aids) the individual in the sit-to-stand motion and the stand-to-sit motion. For example, one or more weights may be attached as needed in the area of the latching mechanism 116 or at an end of the parallel bars opposite the entrance to the support frame system. The counter balance or weight can be used to assist those individuals who have decreased or diminished strength to transition between the sitting and standing positions on non-automated units. The stand-to-sit motion is similar to the sit-to-stand motion.

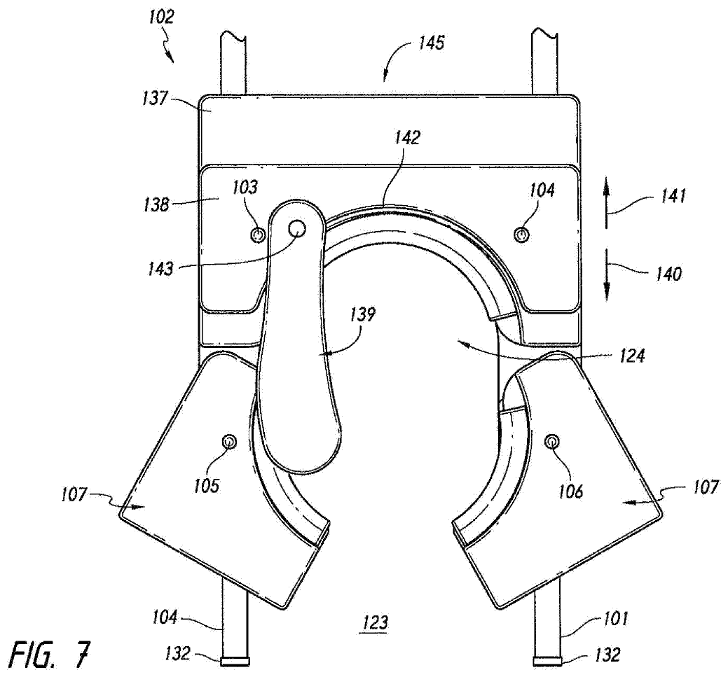

As illustrated in FIG. 7, the support frame system 102 can have one or more adjustable plate(s). The adjustable plate(s) can be used to create a better fit for each individual. The adjustable plate(s) can make the individual more secure, if necessary or desired. As illustrated in FIG. 7, the adjustable plate(s) can be attached to the lower layer 137 of the support frame system 102. In some embodiments, the adjustable plate(s) can be attached to another layer of the support frame system 102 or can be on the same layer as the lower layer 137. In some embodiments, the adjustable plate(s) can be a top layer of the support frame system 102. In some embodiments, when there is more than one adjustable plate, the adjustable plates can be on the same and/or different layers of the support frame system 102. The adjustable plate(s) can be on the same or different layers than the enclosure arms 107. As illustrated in FIG. 7, an adjustable slide plate 138 can be on the same level as the enclosure arms 107 and an adjustable arm plate 139 can be above the enclosure arms 107. In some embodiments, the adjustable slide plate 138 and adjustable arm plate 139 can be on the same level. In some embodiments, the adjustable slide plate 138 and adjustable arm plate 139 can be an integral piece. In some embodiments, the adjustable slide plate 138 and the adjustable arm plate 139 can be discrete pieces.

As illustrated in FIG. 7, the adjustable slide plate 138 can be positioned on the front portion of the support frame system 102 opposite from the opening 123. The individual enters the support frame system through opening 123. The enclosure arms 107 can close behind the individual, creating an interior area 124. The adjustable slide plate 138 can be moved closer to the individual, in direction 141, and can make the interior area 124 smaller. The adjustable slide plate 138 can move in a direction generally parallel to the direction of the parallel bars 101. The adjustable slide plate 138 can be moved away from the individual in direction 141. The adjustable slide plate 138 can have an interior cutout 142. The cutout 142 can be any shape that accommodates the individual's torso, for example, arcuate, ergonomic, elliptical, semi-circular, or the like. In some embodiments, the interior surface of the adjustable slide plate would touch the torso of the individual.

As illustrated in FIG. 7, the adjustable arm plate 139 can be positioned to be on the side of the individual. There can be one or more arm plates 139. There can be an arm plate 139 on each side of the individual. The arm plate 139 can be rotatable. As illustrated in FIG. 7, the arm plate 139 can be connected to slide plate 138 at point 143. The arm plate 139 can be rotatable about point 143. The arm plate 139 can have a handle, gripping structure, and/or cutout located at or near the point 143. In some embodiments, the arm plate 139 can be slidable. The arm plate 139 can be moved in the 140 and 141 directions, to position the arm plate under the individual's elbow. The arm plate 139 can be moved laterally from side to side of the support frame system 102. An optional padding on the arm plate 139 can provide extra pressure point padding. The arm plate 139 can be moved closer to the individual and make the interior area 124 smaller, creating a tighter fit to increase the individual's sense of safety. The positioning of the arm plate 139 can depend on the location of the individual's elbow when the individual is in the support frame system 102. The size of the arm plate 139 can depend on the size of the individual. The arm plate 139 can be secured to a surface of the support frame system 102 with hook and loop fasteners or other attachment structures to precisely position the arm plate 139 for optimal user comfort. With the arm plate 139 and the slide plate 138, the individual's movement in the support frame system 102 can be limited and the individual can have less room if any to lean. In some embodiments, one or more adjustable bars are used instead of or in addition to the adjustable plate(s). The bars can be padded or unpadded. In some configurations, the adjustable bar(s) have a smaller footprint than the plate(s) when viewed from above.

As illustrated in FIG. 8, the system 100 can include one or more mobility structures 180. The mobility structures 180 can be, for example, wheels, casters, leveling casters, sliders, or some combination thereof. In the illustrated embodiment, each of the mobility structures 180 is a leveling caster, and each vertical support 119 has a mobility structure 180 connected to the bottom end thereof. The leveling casters can include a wheel 182 and a brake or brace 184. The brake/brace 184 can be transitioned between an engaged position where the brake 184 raises the wheel 182 from the ground and a disengage position where the brake 184 is positioned above a lower end of the wheel 182, allowing the wheel 182 to roll. One or more stabilization structures 188 can connect to the vertical supports 119 to provide stability to the system 100. For example, one or more bars can connect one or more of the adjacent pairs of vertical supports 119. Preferably, the two vertical supports 119 do not include bars therebetween in order to avoid blocking entrance of the individual into the system 100. In some embodiments, the stabilizing structures 188 can include gussets, pipes, bars, and/or a combination thereof. The stabilizing structures 188 can be configured to reduce the risk of tilting of one or more of the vertical supports 119 during use.

The terms “approximately,” “about,” and “substantially” as used herein represent an amount close to the stated amount that still performs a desired function or achieves a desired result. For example, in some embodiments, as the context may dictate, the terms “approximately,” “about,” and “substantially” may refer to an amount that is within less than or equal to 10% of the stated amount. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Absolute lengths and/or respective lengths can be extended and/or reduced. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Although the present inventions have been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without individual input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A support frame system for use with parallel bars comprising:
a main body, the main body having an opening;
at least one enclosure arm movable between an open and a closed position relative to the opening, the open position allows a user to enter the support frame system and the closed position inhibits the user from exiting the support frame system; and
a securing mechanism that secures the at least one enclosure arm in the closed position.

2. The support frame system of claim 1, wherein the enclosure arm is rotatable about a vertical axis.

3. The support frame system of claim 1 further comprising at least one handle, the handle extending vertically from a top surface of the main body.

4. The support frame system of claim 1 further comprising at least one handle, the handle extending vertically from a top surface of the enclosure arm.

5. The support frame system of claim 1 further comprising a sliding mechanism that allows the main body to slide along the length of the parallel bars.

6. The support frame system of claim 1, wherein the main body and the at least one enclosure arm in the closed position create an interior area that accommodates a user and is sized to allow the user to turn up to 360 degrees.

7. The support frame system of claim 1 wherein the support frame system is free-standing.

8. The support frame system of claim 1 further comprising at least one cutout in the main body, the cutout positioned for the user to use.

9. The support frame system of claim 1 further comprising at least one cutout in the at least one enclosure arm, the cutout positioned for the user to use.

10. The support frame system of claim 1 further comprising an adjustable plate configured to move toward and away from the user.

11. The support frame system of claim 1 further comprising an arm plate.

12. A parallel bar apparatus comprising:
at least one tiltable parallel bar connected to a vertical support, the at least one parallel bar movable between a horizontal position and a tilted position;
a latching mechanism that releasably secures the at least one parallel bar in the horizontal position.

13. The parallel bar apparatus of claim 12 further comprising a floor deck.

14. The parallel bar apparatus of claim 12 further comprising an end piece that connects the at least one parallel bar with a second parallel bar.

15. An ambulatory assistance system comprising:
at least one parallel bar tiltably connected to a vertical support, the at least one parallel bar movable between a horizontal position and a tilted position;
a support frame system comprising:
a main body, the main body having an opening;
at least one enclosure arm movable between an open and a closed position relative to the opening, the open position allows a user to enter the support frame system and the closed position inhibits the user from exiting the support frame system; and
a sliding mechanism that connects the support frame system and the at least one parallel bar.

16. The system of claim 15, wherein the tilted position of the at least one parallel bar allows a user to access the support frame system from a seated position.

17. The system of claim 15 further comprising a counter balance.

18. The system of claim 15 further comprising a latching mechanism, the latching mechanism secures the at least one parallel bar in the horizontal position.

19. An ambulatory assistance system comprising:
at least one vertical support,
a support frame system rotatably connected to the at least one vertical support and comprising:
a main body, the main body having an opening; and
at least one enclosure arm movable between an open and a closed position relative to the opening, the open position allows a user to enter the support frame system and the closed position inhibits the user from exiting the support frame system; and
an automated height adjustment system that adjusts the at least one vertical support to move the support frame system between a horizontal position and a tilted position.

20. The system of claim 19 wherein the tilted position of the support frame system allows a user to access the support frame system from a seated position.
